(19) United States
(12) Patent Application Publication
(10) Pub. No.: US 2026/0349896 A1
(43) Pub. Date: Nov. 5, 2026

(54) COMPONENT BASED THERMAL MARGIN REPORTING BY A MEMORY SYSTEM

(71) Applicant: Micron Technology, Inc., Boise, ID (US)

(72) Inventors: Paul Henry Chandler Smith, Boise, ID (US); Steffen Buch, Munich (DE); Paolo Amato, Treviglio (BG) (IT); Christian M. Gyllenskog, Meridian, ID (US); Dustin L. Holloway, Meridian, ID (US)

(21) Appl. No.: 19/659,865

(22) Filed: Apr. 27, 2026

Related U.S. Application Data
(60) Provisional application No. 63/800,126, filed on May 5, 2025.

(51) Int. Cl. G06F 11/30; G06F 1/20; G06F 11/07

(52) U.S. Cl. CPC G06F 11/3058; G06F 1/206; G06F 11/0754

(57) ABSTRACT

Methods, systems, and devices for component based thermal margin reporting by a memory system are described. A memory system may monitor a temperature of one or more components and may receive a first command associated with determining a respective thermal margin for each of the components. The memory system may determine a respective thermal margin for each of the plurality of components of the memory system in accordance with receiving the first command and may transmit a lowest thermal margin associated with each of the components for which a thermal margin was determined.

### CROSS REFERENCE

The present application for patent claims priority to U.S. Patent Application No. 63/800,126 by Smith et al., entitled “COMPONENT BASED THERMAL MARGIN REPORTING BY A MEMORY SYSTEM,” filed May 5, 2025, which is assigned to the assignee hereof, and which is expressly incorporated by reference in its entirety herein.

### TECHNICAL FIELD

The following relates to one or more systems for memory, including component based thermal margin reporting by a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports component based thermal margin reporting by a memory system in accordance with examples as disclosed herein.

FIG. 2 shows an example of a system that supports component based thermal margin reporting by a memory system in accordance with examples as disclosed herein.

FIG. 3 shows an example of a process that supports component based thermal margin reporting by a memory system in accordance with examples as disclosed herein.

FIG. 4 shows a block diagram of a memory system that supports component based thermal margin reporting by a memory system in accordance with examples as disclosed herein.

FIGS. 5 and 6 show flowcharts illustrating a method or methods that support component based thermal margin reporting by a memory system in accordance with examples as disclosed herein.

### DETAILED DESCRIPTION

Memory systems may employ various methods for collecting and reporting temperature data. In some examples, a memory system may utilize a case temperature (e.g., T_{case}, T_{c}) for determining whether its operating temperature is within a defined operating temperature range (e.g., above a lower temperature bound, below an upper temperature bound). As used herein, a case temperature may refer to a temperature of a point (e.g., at a temperature sensor) of the memory system's casing or enclosure. A case temperature is often measured at a center of the top of the package that includes the memory system. However, characterizing a memory system's temperature using its case temperature may increase the design margin of various internal components. For example, because some internal components' temperatures may vary (especially as compared with the case temperature), characterizing a memory system's temperature based on its case temperature can result in the design margin of some or all of the internal components being relatively greater, which may increase cost, electronic leakage, and may otherwise limit the system's overall capabilities. Accordingly, a memory system configured to report one or more internal temperature metrics may be desirable.

A memory system configured to report one or more internal temperature metrics is described herein. In some examples, a memory system may calculate a thermal margin of one or more of its components, and may report its lowest thermal margin to a host system. The memory system may use one or more junction temperatures (e.g., T_{junction}, Tⱼ) to calculate a respective thermal margin. As used herein, a junction temperature may refer to a temperature of a “junction” of a memory system, which may include a temperature of any component (e.g., any internal component) having an internal temperature sensor. Thus, a thermal margin may refer to a difference between a component's tolerances (e.g., maximum or minimum) operating temperature (e.g., T_{j,max}) and its junction temperature (e.g., Tⱼ).

By reporting a lowest thermal margin, a host system may be informed of a specific component (or components) that is operating at or near its temperature bounds. In such instances, the host may perform one or more operations that attempt to cool the respective component. For example, a host system may disable the component or otherwise throttle operations that result in the component being cooled. In other instances, such as during testing operations, reporting such internal temperature metrics may allow for various thermal solutions to be designed for the memory system. That is, providing component-based temperature metrics to a host system (or tester) may facilitate better characterization and validation of thermal solutions based on the system's component temperature limits.

In addition to applicability in memory systems as described herein, techniques for component based thermal margin reporting may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by allowing for certain components to be cooled, or for thermal solutions to be designed for a memory system, which may improve the system's overall performance.

Features of the disclosure are illustrated and described in the context of systems, devices, and circuits. Features of the disclosure are further illustrated and described in the context of processes, block diagrams, and flowcharts.

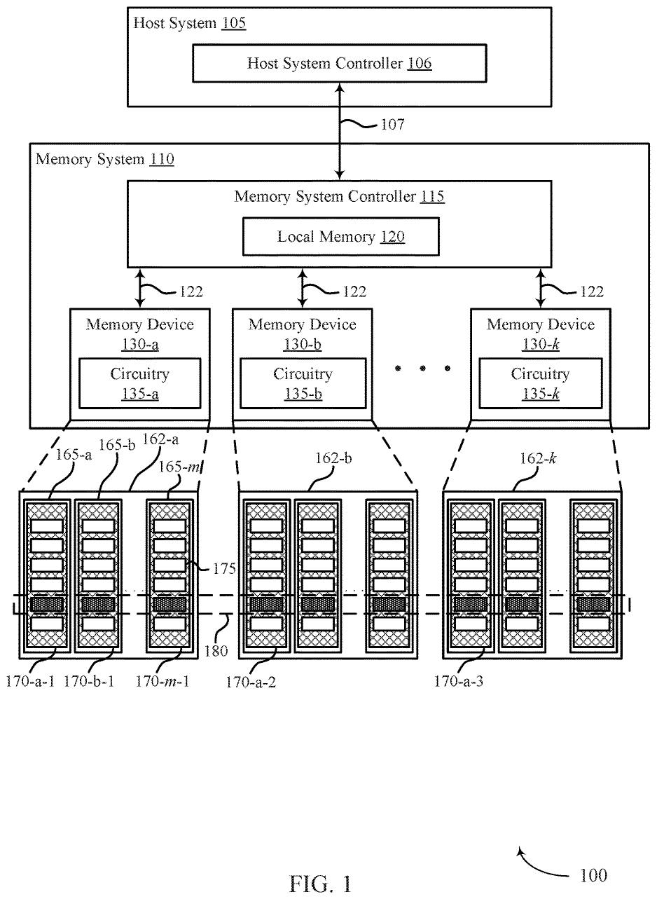

FIG. 1 shows an example of a system 100 that supports component based thermal margin reporting by a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-k, where k represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DDR interfaces, or ONFI interfaces, among other interfaces. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), dynamic random access memory (DRAM), or other memory) that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-k may include circuitry 135-k.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include m planes 165 and each plane may include n blocks 170 (e.g., with the example of FIG. 1 illustrating one block 170 per plane 165), where m and n represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-m, where m represents an Mth plane. The memory die 162-b and the memory die 162-k may also include M planes. In some cases, an individual block 170 may be referred to as a physical block, and a virtual block 180 may refer to a group of blocks 170 within which concurrent operations may occur. A virtual block 180 may be a logical structure that includes a plurality of blocks 170, and different blocks 170 of the plurality of blocks 170 may come from different planes 165 or different memory dies 162. In some cases, a virtual block 180 may include blocks 170 from different memory devices 130 (e.g., including blocks in one or more planes 165 of memory device 130-a, memory device 130-b, and memory device 130-k). In some examples, a virtual block 180 may include a respective block 170 from each plane 165 (e.g., a block 170 from each plane 165) of one or more memory dies 162.

In some cases, the blocks 170 within a virtual block 180 may have the same block address within their respective planes 165. For example, block 170-a-1 may be “block 0” of a first plane 165 of die 162-a, block 170-a-2 may be “block 0” of a first plane 165 of die 162-b, block 170-a-3 may be “block 0” of a first plane 165 of die 162-k, and so on. By way of further example, block 170-b-1 may be “block 1” of a first plane 165 of die 162-a and block 170-m-1 may be “block m-1” of die 162-a, where m represents an Mth block. The memory die 162-b and the memory die 162-k may also include M blocks 170. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

In some examples, the memory system 110 may calculate a thermal margin of one or more of its components, and may report its lowest thermal margin to the host system 105 or to a tester (not shown). The memory system 110 may use one or more junction temperatures (e.g., T_{junction}, Tⱼ) to calculate a respective thermal margin. As used herein, a junction temperature may refer to a temperature of a “junction” of a memory system, which may include a temperature of any component (e.g., any internal component) having an internal temperature sensor. Thus, a thermal margin may refer to a difference between a component's tolerances (e.g., maximum or minimum) operating temperature (e.g., T_{j,max}) and its junction temperature (e.g., Tⱼ).

By reporting a lowest thermal margin, the host system 105 may be informed of a specific component (or components) that is operating at or near its temperature bounds. In such instances, the host system 105 may perform one or more operations that attempt to cool the respective component. For example, the host system 105 may disable the component or otherwise throttle operations that result in the component being cooled. In other instances, such as during testing operations, reporting such internal temperature metrics may allow for various thermal solutions to be designed for the memory system 110. That is, providing component-based temperature metrics to a host system 105 (or tester) may facilitate better characterization and validation of thermal solutions based on the system's component temperature limits.

The system 100 may include any quantity of non-transitory computer readable media that support component based thermal margin reporting by a memory system. For example, the host system 105 (e.g., a host system controller 106), the memory system 110 (e.g., a memory system controller 115), or a memory device 130 (e.g., a circuitry 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by circuitry 135), may cause the host system 105, the memory system 110, or the memory device 130 to perform associated functions as described herein.

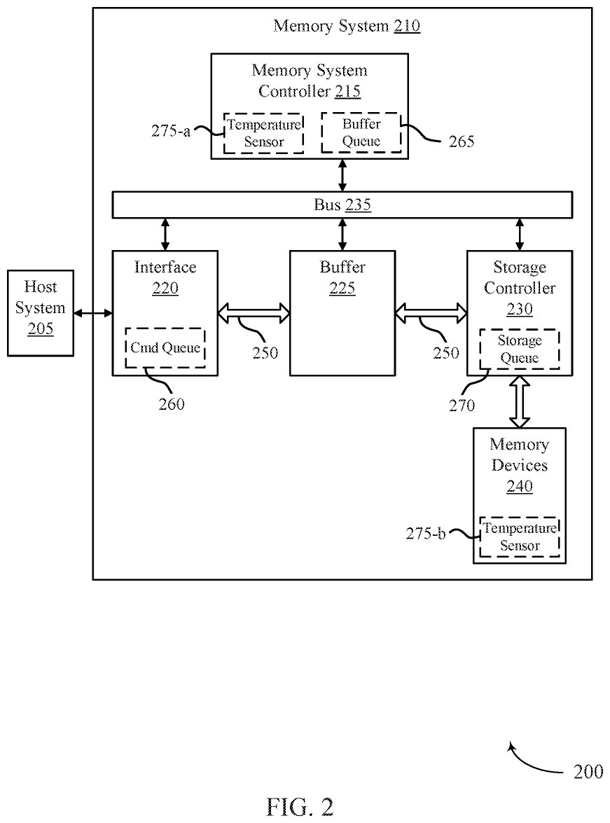

FIG. 2 shows an example of a system 200 that supports component based thermal margin reporting by a memory system in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of the circuitry 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

In some instances, the memory system 210 may include one or more temperature sensors 275. For example, the memory system controller 215 may include or otherwise be associated with a temperature sensor 275-a and the memory devices 240 may include or otherwise be associated with a temperature sensor 275-b. In some cases, the memory devices 240 may include or otherwise be associated with a single temperature sensor 275-b, each respective memory device may include its own temperature sensor 275, or each memory die of each respective memory device may include its own temperature sensor 275. In other examples, each temperature sensor 275 illustrated in FIG. 2 may represent multiple temperature sensors 275. For example, the memory system controller 215 may include or otherwise be associated with multiple temperature sensors 275-a and the memory devices 240 may include or otherwise be associated with multiple temperature sensors 275-b. In other examples although only the memory system controller 215 and the memory devices 240 are illustrated as having a respective temperature sensor 275, any component of the memory system 210 may include or be associated with one or more (e.g., one or multiple) respective temperature sensors 275.

Each temperature sensor 275 may monitor the temperature of a respective component. The respective temperatures (e.g., the respective junction temperatures) may be provided to the memory system controller 215, and the memory system controller 215 may calculate a thermal margin for each respective component. For example, the memory system controller 215 may store an indication of one or more tolerances for each component. That is, the memory system controller 215 may store an indication of a maximum (or minimum) operating temperature (e.g., Tⱼ) for each component. In other instances, the respective tolerances may be stored to a different portion of the memory system 210 (e.g., to one or more memory devices 240, to volatile memory) and the memory system controller 215 may access the stored information when calculating respective thermal margins.

In some examples, the memory system controller 215 may calculate a thermal margin of one or more components, and may report its lowest thermal margin to the host system 205 or to a tester (not shown). The memory system controller 215 may use one or more junction temperatures (e.g., T_{junction}, Tⱼ) to calculate a respective thermal margin. For example, the memory system controller 215 may calculate a thermal margin for a respective component using Equation (1).

Thermal Margin=Tj,max−Tj+Offset (1)

In some examples, an offset may be added to the thermal margin calculation. The offset may allow for a respective thermal margin value to be reported when Tⱼ exceeds T_{j,max}. For example, the offset value may be set at 11 °C. If Tⱼ>T_{j,max}+10 °C, the thermal margin value may be reported to the host system (e.g., the value may not become saturated). As described herein, the offset value may be set as a matter of design choice and, in some instances, may be configurable.

By reporting a lowest thermal margin, the host system 205 may be informed of a specific component (or components) that is operating at or near its temperature bounds. In such instances, the host system 205 may perform one or more operations that attempt to cool the respective component. For example, the host system 205 may disable the component or otherwise throttle operations that result in the component being cooled. In other instances, such as during testing operations, reporting such internal temperature metrics may allow for various thermal solutions to be designed for the memory system 210. That is, providing component-based temperature metrics to a host system 205 (or tester) may facilitate better characterization and validation of thermal solutions based on the system's component temperature limits.

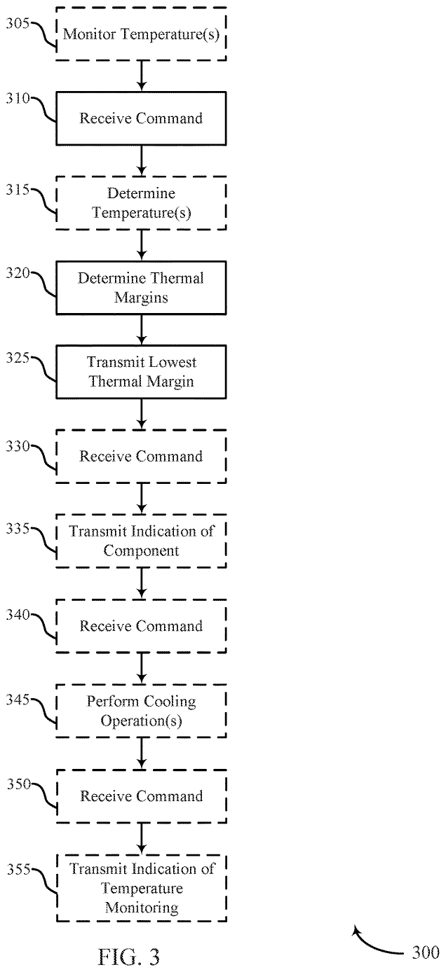

FIG. 3 shows an example of a process 300 that supports component based thermal margin reporting by a memory system in accordance with examples as disclosed herein. The operations of process 300 may be performed by a memory system or one or more controllers associated with a memory system as described herein. For example, the operations of process 300 may be performed by a memory system 210 or a memory system controller 215 as described with reference to FIG. 2. The process 300 may also include reference to one or more temperature sensors, which may be examples of the temperature sensors 275 as described with reference to FIG. 2. The process 300 may illustrate aspects of calculating (and reporting) thermal margins of individual components using respective junction temperatures. Calculating and providing thermal margins accordingly may allow for individual components to be cooled, which may improve the system's overall performance, and for improved characterization and validation of thermal solutions based on the system's component temperature limits.

In the following description of the process 300, the operations may occur in a different order than the example order shown and, in some examples, may be performed by one or more different devices other than those described as examples. Some operations also may be omitted from the process 300, and other operations may be added to the process 300. Further, although some operations may be shown to occur at different times for discussion purposes, these operations may actually occur at the same time.

At 305, one or more temperatures of a memory system 210 may be monitored. For example, respective temperature sensors 275 may monitor junction temperatures (e.g., Tⱼ) of one or more components of a memory system 210. In some instances, the temperatures may be monitored such that, when a command (e.g., a bInternalThermalMargin command, a first command) is received, the memory system controller 215 may determine a component's respective thermal margin.

In some examples, temperature values associated with each component's junction temperature may be stored to the associated memory system 210 and may be accessed by the memory system controller 215 when calculating respective thermal margins. In other examples, each component's junction temperature may be monitored (e.g., over a duration, when the memory system is active) and a highest (or lowest) temperature for a respective component may be stored to the memory system. When a new highest (or lowest) operating temperature is measured, the associated value may be stored to the memory system 210 (e.g., the prior temperature value may be overwritten). The memory system 210 may thus monitor junction temperatures such that the respective temperatures can be used to calculate one or more thermal margins when a command is received.

Additionally or alternatively, each junction temperature may be dependent on a number of factors. For example, a respective junction temperature may be based on an ambient temperature proximate to a respective component, a workload of the respective component (e.g., whether the component is executing an associated operation), a proximity of the component to an external heat source, heat drawn from the upper or lower portion of the memory system 210, and the like. Due to these factors, a junction temperature of a component may account for more factors than a case temperature, which may result in a host system 205 or tester obtaining more accurate temperature information.

At 310, a command may be received. In some instances, a memory system controller 215 may receive a command from a host system 205 or from a tester. The command, which may be referred to as a first command, may be an example of an attribute (e.g., a command) as shown below in Table 1.

TABLE 1
ATTRIBUTE

| | | | Type # | | |
|---|---|---|---|---|---|
| | Access | | #Ind. | | |
| NAME | Property | Size | #Sel. | MDV | Description |
| bInternalThermalMargin | Read/Volatile | 1 | D | — | Internal device |
| | | byte | | | junction |
| | | | | | temperature margin |
| | | | | | below maximum |
| | | | | | design temperature. |
| | | | | | For each sub- |
| | | | | | component, i, |
| | | | | | within the device, |
| | | | | | the margin is |
| | | | | | calculated by |
| | | | | | T_{j, max, i} − T_{j, i} + 11C. |
| | | | | | The returned value |
| | | | | | is the lowest |
| | | | | | calculated value |
| | | | | | across sub- |
| | | | | | components. |
| | | | | | Values will saturate |
| | | | | | at 01h if T_{j, i} > |
| | | | | | T_{j, max, i} + 10C. |
| | | | | | Temperatures used |
| | | | | | for the computation |
| | | | | | are internal device |
| | | | | | junction |
| | | | | | temperatures, |
| | | | | | measured in |
| | | | | | Celsius. |
| | | | | | A value of 00h |
| | | | | | shall be returned if |
| | | | | | this feature is not |
| | | | | | supported. |

The first command may request that the memory system controller 215 provide an indication of the lowest thermal margin of the memory system 210 to the host system 205 or to the tester. The lowest thermal margin may be used by the host system 205 to perform one or more operations to cool the associated component or by a tester in analyzing or determining thermal solutions for the memory system 210. If the memory system 210 does not support calculating thermal margins using Tⱼ, the memory system controller 215 may return (e.g., transmit) a value of 00 h to the host system 205 or to a tester.

At 315, one or more temperatures may be determined. In some examples, the memory system controller 215 may determine a junction temperature of each component of the memory system 210 in response to the command being received at 310. For example, the temperature sensors 275 may have been monitoring respective component temperatures since 305 and, in some examples, the temperatures may have been stored to the memory system. In the instance that the temperatures are monitored (and not stored), the memory system controller 215 may obtain an instantaneous temperature reading from each temperature sensor 275 at 315. In the instance that the temperature values are stored to the memory system 210, the memory system controller 215 may obtain a stored temperature reading for each temperature sensor 275 at 315. The memory system controller 215 may use the temperature readings to determine a thermal margin for each component associated with a respective junction temperature).

At 320, one or more thermal margins may be determined. In some examples, the memory system controller 215 may determine a thermal margin for each of the components for which a temperature value was obtained. As described herein, the thermal margin of each component may be calculated using Equation (1). In some instances, upon calculating a respective thermal margin, the memory system controller 215 may store an indication to the memory system 210 (e.g., to one or more memory devices 240, to volatile memory).

The memory system controller 215 may compare each of the calculated thermal margins to determine a lowest thermal margin. For example, the memory system controller 215 may store an indication of each thermal margin and may determine a lowest indication. In some examples, the memory system controller 215 may calculate a value (e.g., hex value) for each thermal margin (or, in some examples, for the lowest thermal margin) that may be transmitted to a host system 205 or to a tester. Examples of the values calculated for each thermal margin are shown with reference to Table 2 and Table 3.

TABLE 2

| | | | Thermal | Calculated |
|---|---|---|---|---|
| Component | T_{j, max} | Tⱼ | Margin | Value (Hex) |
| 1h | 125 | 109 | 27 | 1Bh |
| 2h | 115 | 111 | 15 | Fh |
| 3h | 115 | 112 | 14 | Eh |
| 4h | 115 | 112 | 14 | Eh |
| 5h | 115 | 114 | 12 | Ch |
| 6h | 115 | 115 | 11 | Bh |
| 7h | 115 | 116 | 10 | Ah |
| 8h | 115 | 117 | 9 | 9h |
| 9h | 115 | 124 | 2 | 2h |

TABLE 3

| | | | Thermal | Calculated |
|---|---|---|---|---|
| Component | T_{j, max} | Tⱼ | Margin | Value (Hex) |
| 1h | 125 | 108 | 28 | 1Ch |
| 2h | 115 | 95 | 31 | 1Fh |
| 3h | 115 | 94 | 32 | 20h |
| 4h | 115 | 95 | 31 | 1Fh |
| 5h | 115 | 96 | 30 | 1Eh |
| 6h | 115 | 94 | 32 | 20h |
| 7h | 115 | 93 | 33 | 21h |
| 8h | 115 | 94 | 32 | 20h |
| 9h | 115 | 94 | 32 | 20h |

As shown in Table 2, component 9 h may be associated with the lowest thermal margin and value (e.g., hex value) 2 h may be generated. As shown in Table 3, component 1 h may be associated with the lowest thermal margin and value (e.g., hex value) 1 Ch may be generated. In some examples, a same value (e.g., a same hex value) may be generated for all components having a same thermal margin.

At 325, a lowest thermal margin may be transmitted. In some examples, the memory system controller 215 may transmit a lowest thermal margin to a host system 205 or to a tester. By way of example, for Table 2, a value (e.g., a hex value) 2 h may be transmitted to a host system 205 or to a tester and, for Table 3, a value (e.g., a hex value) 1 h may be transmitted to a host system 205 or to a tester. If the memory system 210 does not support indicating which component is associated with a lowest thermal margin, the memory system controller 215 may transmit a value of 00 h (or another value selected to be outside of the normal operating temperature range of the device) to the host system 205 or to a tester.

At 330, a command may be received. In some instances, a memory system controller 215 may receive a command from a host system 205 or from a tester. The command, which may be referred to as a third command, may be an example of an attribute (e.g., a command) as shown below in Table 4.

TABLE 4
ATTRIBUTE

| | | | Type # | | |
|---|---|---|---|---|---|
| | Access | | #Ind. | | |
| NAME | Property | Size | #Sel. | MDV | Description |
| bSubcomponentWithLeastThermalMargin | Read/Volatile | 1 byte | D | Vendor | Vendor specific |
| | | | | Specific | value used to |
| | | | | | indicate which |
| | | | | | subcomponent of the |
| | | | | | UFS device has the |
| | | | | | least thermal margin. |
| | | | | | A value of 00h shall |
| | | | | | be returned if this |
| | | | | | feature is not |
| | | | | | supported. |

The third command may request that the memory system controller 215 provide an indication of which component (or subcomponent) is associated with the lowest thermal margin. In response to receiving the third command, which may be an example of a vendor specific command, the memory system controller 215 may determine which component (or subcomponent) is associated with the lowest thermal margin.

At 335, an indication of a component having the lowest thermal margin may be transmitted. In some examples, the memory system controller 215 may transmit an indication of the lowest thermal margin to a host system 205 or to a tester. By way of example, for Table 2, a value (e.g., a hex value) 9 h may be transmitted to a host system 205 or to a tester to indicate that component 9 h is associated with the lowest thermal margin. For Table 3, a value (e.g., a hex value) 1 h may be transmitted to a host system 205 or to a tester to indicate that component 1 h is associated with the lowest thermal margin. The information transmitted to a host system 205 may be used (e.g., by the host system) to perform one or more operations to cool the associated component. The information transmitted to a tester may be used (e.g., by the tester) for improved characterization and validation of thermal solutions based on the system's component temperature limits.

At 340, a command may be received. In some instances, a memory system controller 215 may receive a command from a host system 205. The command may be referred to as a second command and may initiate one or more operations (e.g., at the memory system) to cool a component having the lowest thermal margin (e.g., the component associated with the indication transmitted at 335).

At 345, one or more cooling operations associated with lowering a temperature of a component having the lowest thermal margin may be performed. In some examples, the memory system controller 215 may initiate performing the one or more cooling operations based on receiving the second command at 340. For example, the memory system controller 215 may disable the component having the lowest thermal margin. The memory system controller may, additionally or alternatively, disable one or more components proximate to the component having the lowest thermal margin to lower its temperature. In other examples, the memory system controller may throttle or otherwise postpone executing operations (e.g., access operations) until the temperature of the component is below a threshold (e.g., is within a desired operational temperature range).

At 350, a command may be received. In some instances, a memory system controller 215 may receive a command from a host system 205 or from a tester. The command, which may be referred to as a fourth command, may be an example of a descriptor (e.g., a command) as shown below in Table 5.

TABLE 5
DESCRIPTOR

| | | | | User | |
|---|---|---|---|---|---|
| Offset | Size | NAME | MDV | Conf. | Description |
| | 1 | bTemperatureMeasurementLocation | Device | No | Value |
| | | | Specific | | indicating |
| | | | | | whether |
| | | | | | temperatures |
| | | | | | for extreme |
| | | | | | temperature |
| | | | | | events are |
| | | | | | measured based |
| | | | | | on Tcase (TC) |
| | | | | | or Tjunction |
| | | | | | (TJ). |
| | | | | | FFh means TC |
| | | | | | 01h-FEh means |
| | | | | | TJ |
| | | | | | 00h means |
| | | | | | value is not |
| | | | | | reported. |

The fourth command may request a type of temperature monitoring being performed by the memory system 210. For example, the type of temperature monitoring may include a first type of temperature monitoring where the memory system 210 monitors T_{case}. In other examples, the type of temperature monitoring may include a second type of temperature monitoring where the memory system 210 monitors Tⱼ. As described herein, the memory system 210 may monitor Tⱼ, however the memory system is configured to and capable of measuring T_{case}.

At 355, an indication of the temperature monitoring performed by the memory system 210 may be transmitted. In some instances, a memory system controller 215 may transmit an indication of whether the memory system 210 is monitoring temperature according to a first type of temperature monitoring or according to a second type of temperature monitoring. If the memory system 210 is monitoring temperature according to a first type of temperature monitoring, the memory system controller 215 may transmit a value (e.g., a hex value) FFh to the host system 205 or to a tester. If the memory system 210 is monitoring temperature according to a second type of temperature monitoring, the memory system controller 215 may transmit a value (e.g., a hex value) 01 h-FEh to the host system 205 or to a tester. If the memory system 210 does not support different types of temperature monitoring, the memory system controller 215 may transmit a value of 00 h to the host system 205 or to a tester.

In other examples, the memory system 210 may support reporting when a component's temperature is too high or too low. For example, when a host system 205 or tester is to be made aware that a component's temperature is too high or too low, the memory system controller 215 may transmit a command (e.g., an attribute) to the host system 205 or to the tester indicating as much. The memory system controller 215 may transmit a command (e.g., a fifth command, a wExceptionEventStatus Attribute) that indicates whether an operating temperature of the memory system 210 satisfies a first threshold temperature value that is associated with an upper bound of an operating temperature range of the memory system (e.g., that a component is too hot) or a second threshold temperature value that is associated with a lower bound of the operating temperature range of the memory system (e.g., that a component is too cold).

When TOO_HIGH_TEMP in wExceptionEventStatus is raised, it is recommended for host system 205 to do throttling or other cooling activities for lowering the temperature of the memory system 210 (e.g., lowering the temperature of the specific component of the memory system 210). When TOO_LOW_TEMP in wExceptionEventStatus is raised, it is recommended for host system 205 to do activities for increasing the temperature of the memory system 210 (e.g., raising the temperature of the specific component of the memory system 210). Calculating and providing thermal margins accordingly may allow for individual components to be cooled, which may improve the system's overall performance, and for improved characterization and validation of thermal solutions based on the system's component temperature limits.

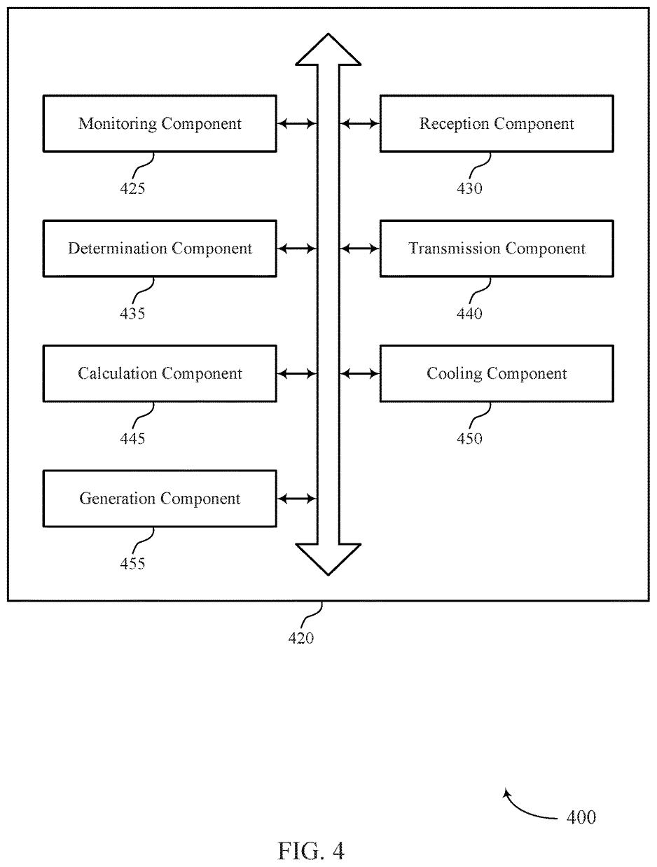

FIG. 4 shows a block diagram 400 of a memory system 420 that supports component based thermal margin reporting by a memory system in accordance with examples as disclosed herein. The memory system 420 may be an example of aspects of a memory system as described with reference to FIGS. 1 through 3. The memory system 420, or various components thereof, may be an example of means for performing (e.g., to cause the memory system 420 to perform) various aspects of component based thermal margin reporting by a memory system as described herein. For example, the memory system 420 may include a monitoring component 425, a reception component 430, a determination component 435, a transmission component 440, a calculation component 445, a cooling component 450, a generation component 455, or any combination thereof. Each of these components, or components of subcomponents thereof (e.g., one or more processors, one or more memories), may communicate, directly or indirectly, with one another (e.g., via one or more buses).

The monitoring component 425 may be configured as or otherwise support a means for monitoring a temperature of each component of a plurality of components. The reception component 430 may be configured as or otherwise support a means for receiving a first command associated with determining a respective thermal margin for each of the plurality of components in accordance with monitoring the temperature of each component of the plurality of components. The determination component 435 may be configured as or otherwise support a means for determining the respective thermal margin for each of the plurality of components of the memory system in accordance with receiving the first command. The transmission component 440 may be configured as or otherwise support a means for transmitting a lowest thermal margin of the respective thermal margins associated with each of the plurality of components.

In some examples, the reception component 430 may be configured as or otherwise support a means for receiving, in accordance with transmitting the lowest thermal margin, a second command associated with lowering a temperature of a component having the lowest thermal margin. In some examples, the cooling component 450 may be configured as or otherwise support a means for performing one or more operations that result in cooling of the component having the lowest thermal margin in accordance with receiving the second command.

In some examples, the reception component 430 may be configured as or otherwise support a means for receiving, by the memory system, a third command associated with determining a component of the plurality of components having the lowest thermal margin. In some examples, the transmission component 440 may be configured as or otherwise support a means for transmitting an indication of the component having the lowest thermal margin in accordance with receiving the third command.

In some examples, the determination component 435 may be configured as or otherwise support a means for determining, among a plurality of indicators associated with each of the plurality of components, an indicator associated with the component having the lowest thermal margin in accordance with receiving the third command and determining the respective thermal margin for each of the plurality of components of the memory system. In some examples, the generation component 455 may be configured as or otherwise support a means for generating a value in accordance with determining the indicator associated with the component having the lowest thermal margin, where the indication includes the value.

In some examples, the reception component 430 may be configured as or otherwise support a means for receiving a fourth command associated with indicating a type of temperature monitoring performed by the memory system, where the type of temperature monitoring includes a first type associated with an enclosure temperature of the memory system or a second type associated with a temperature of one or more components of the memory system.

In some examples, the transmission component 440 may be configured as or otherwise support a means for transmitting an indication that the memory system performs the second type of temperature monitoring in accordance with receiving the fourth command and monitoring the temperature of each component of the plurality of components.

In some examples, to support determining the respective thermal margin for each of the plurality of components of the memory system, the determination component 435 may be configured as or otherwise support a means for determining a difference between a maximum operating temperature of a respective component and a summation of the temperature of the respective component and an offset value.

In some examples, the determination component 435 may be configured as or otherwise support a means for determining, among the respective thermal margins for each of the plurality of components, the lowest thermal margin in accordance with determining the respective thermal margin for each of the plurality of components of the memory system, where transmitting the lowest thermal margin is in accordance with determining the lowest thermal margin.

In some examples, the determination component 435 may be configured as or otherwise support a means for determining an instantaneous temperature of each component of the plurality of components in accordance with monitoring the temperature of each component of the plurality of components and receiving the first command, where determining the respective thermal margin for each of the plurality of components of the memory system is in accordance with determining the instantaneous temperature of each component.

In some examples, the instantaneous temperature of each component is in accordance with an ambient temperature associated with a respective component, a workload of a respective component, a proximity of a respective component to an external heat source, or any combination thereof.

In some examples, the determination component 435 may be configured as or otherwise support a means for determining that an operating temperature of the memory system satisfies a first threshold temperature value that is associated with an upper bound of an operating temperature range of the memory system or a second threshold temperature value that is associated with a lower bound of the operating temperature range of the memory system. In some examples, the transmission component 440 may be configured as or otherwise support a means for transmitting a fifth command indicating that the operating temperature of the memory system satisfies the first threshold temperature and the second threshold temperature in accordance with determining that the operating temperature of the memory system satisfies the first threshold temperature value and the second threshold temperature value.

In some examples, the reception component 430 may be configured as or otherwise support a means for receiving a sixth command associated with adjusting the operating temperature of the memory system in accordance with transmitting the fifth command. In some examples, the cooling component 450 may be configured as or otherwise support a means for performing one or more operations to adjust the operating temperature of the memory system in accordance with receiving the sixth command.

In some examples, the reception component 430 may be configured as or otherwise support a means for receiving a first command associated with determining a respective thermal margin for each of a plurality of components of the memory system. The calculation component 445 may be configured as or otherwise support a means for calculating a respective thermal margin for each of the plurality of components of the memory system in accordance with receiving the first command. In some examples, the determination component 435 may be configured as or otherwise support a means for determining a lowest thermal margin of the respective thermal margins in accordance with calculating a respective thermal margin for each of the plurality of components of the memory system. In some examples, the transmission component 440 may be configured as or otherwise support a means for transmitting a lowest thermal margin of the respective thermal margins associated with each of the plurality of components.

In some examples, the determination component 435 may be configured as or otherwise support a means for determining a temperature of each component of a plurality of components in accordance with receiving the first command.

In some examples, the temperature of each component is in accordance with an ambient temperature associated with a respective component, a workload of a respective component, a proximity of a respective component to an external heat source, or any combination thereof.

In some examples, the reception component 430 may be configured as or otherwise support a means for receiving, in accordance with transmitting the lowest thermal margin, a second command associated with lowering a temperature of a component having the lowest thermal margin. In some examples, the cooling component 450 may be configured as or otherwise support a means for performing one or more operations that result in cooling of the component having the lowest thermal margin in accordance with receiving the second command.

In some examples, the reception component 430 may be configured as or otherwise support a means for receiving, by the memory system, a third command associated with determining a component of the plurality of components having the lowest thermal margin. In some examples, the transmission component 440 may be configured as or otherwise support a means for transmitting an indication of the component having the lowest thermal margin in accordance with receiving the third command.

In some examples, the determination component 435 may be configured as or otherwise support a means for determining, among a plurality of indicators associated with each of the plurality of components, an indicator associated with the component having the lowest thermal margin in accordance with receiving the third command and determining the respective thermal margin for each of the plurality of components of the memory system. In some examples, the generation component 455 may be configured as or otherwise support a means for generating a value in accordance with determining the indicator associated with the component having the lowest thermal margin, where the indication includes the value.

In some examples, the reception component 430 may be configured as or otherwise support a means for receiving a fourth command associated with indicating a type of temperature monitoring performed by the memory system, where the type of temperature monitoring includes a first type associated with an enclosure temperature of the memory system or a second type associated with a temperature of one or more components of the memory system.

In some examples, the transmission component 440 may be configured as or otherwise support a means for transmitting an indication that the memory system performs the second type of temperature monitoring in accordance with receiving the fourth command and monitoring the temperature of each component of the plurality of components.

In some examples, to support calculating the respective thermal margin for each of the plurality of components of the memory system, the calculation component 445 may be configured as or otherwise support a means for calculating a difference between a maximum operating temperature of a respective component and a temperature of the respective component and an offset value.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the memory system 420 to perform one or more operations. In some examples, the described functionality of the memory system 420, or various components thereof, may be implemented at least in part by instructions (e.g., stored in memory, non-transitory computer-readable medium) executable by such at least one processor to cause the memory system 420 to perform one or more operations.

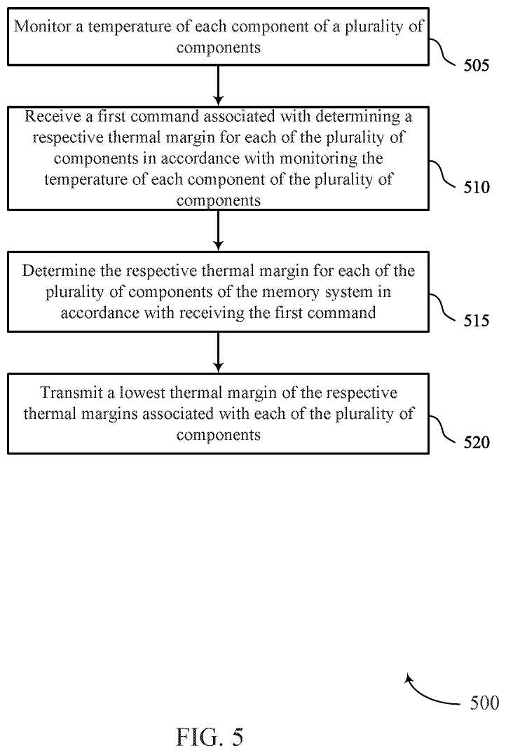

FIG. 5 shows a flowchart illustrating a method 500 that supports component based thermal margin reporting by a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include monitoring a temperature of each component of a plurality of components. In some examples, aspects of the operations of 505 may be performed by a monitoring component 425.

At 510, the method may include receiving a first command associated with determining a respective thermal margin for each of the plurality of components in accordance with monitoring the temperature of each component of the plurality of components. In some examples, aspects of the operations of 510 may be performed by a reception component 430.

At 515, the method may include determining the respective thermal margin for each of the plurality of components of the memory system in accordance with receiving the first command. In some examples, aspects of the operations of 515 may be performed by a determination component 435.

At 520, the method may include transmitting a lowest thermal margin of the respective thermal margins associated with each of the plurality of components. In some examples, aspects of the operations of 520 may be performed by a transmission component 440.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for monitoring a temperature of each component of a plurality of components; receiving a first command associated with determining a respective thermal margin for each of the plurality of components in accordance with monitoring the temperature of each component of the plurality of components; determining the respective thermal margin for each of the plurality of components of the memory system in accordance with receiving the first command; and transmitting a lowest thermal margin of the respective thermal margins associated with each of the plurality of components.

Aspect 2: The method, apparatus, or non-transitory computer-readable medium of aspect 1, further including operations, features, circuitry, logic, means, or instructions, or any combination thereof for receiving, in accordance with transmitting the lowest thermal margin, a second command associated with lowering a temperature of a component having the lowest thermal margin and performing one or more operations that result in cooling of the component having the lowest thermal margin in accordance with receiving the second command.

Aspect 3: The method, apparatus, or non-transitory computer-readable medium of any of aspects 1 through 2, further including operations, features, circuitry, logic, means, or instructions, or any combination thereof for receiving, by the memory system, a third command associated with determining a component of the plurality of components having the lowest thermal margin and transmitting an indication of the component having the lowest thermal margin in accordance with receiving the third command.

Aspect 4: The method, apparatus, or non-transitory computer-readable medium of aspect 3, further including operations, features, circuitry, logic, means, or instructions, or any combination thereof for determining, among a plurality of indicators associated with each of the plurality of components, an indicator associated with the component having the lowest thermal margin in accordance with receiving the third command and determining the respective thermal margin for each of the plurality of components of the memory system and generating a value in accordance with determining the indicator associated with the component having the lowest thermal margin, where the indication includes the value.

Aspect 5: The method, apparatus, or non-transitory computer-readable medium of any of aspects 1 through 4, further including operations, features, circuitry, logic, means, or instructions, or any combination thereof for receiving a fourth command associated with indicating a type of temperature monitoring performed by the memory system, where the type of temperature monitoring includes a first type associated with an enclosure temperature of the memory system or a second type associated with a temperature of one or more components of the memory system.

Aspect 6: The method, apparatus, or non-transitory computer-readable medium of aspect 5, further including operations, features, circuitry, logic, means, or instructions, or any combination thereof for transmitting an indication that the memory system performs the second type of temperature monitoring in accordance with receiving the fourth command and monitoring the temperature of each component of the plurality of components.

Aspect 7: The method, apparatus, or non-transitory computer-readable medium of any of aspects 1 through 6, where determining the respective thermal margin for each of the plurality of components of the memory system includes operations, features, circuitry, logic, means, or instructions, or any combination thereof for determining a difference between a maximum operating temperature of a respective component and a summation of the temperature of the respective component and an offset value.

Aspect 8: The method, apparatus, or non-transitory computer-readable medium of any of aspects 1 through 7, further including operations, features, circuitry, logic, means, or instructions, or any combination thereof for determining, among the respective thermal margins for each of the plurality of components, the lowest thermal margin in accordance with determining the respective thermal margin for each of the plurality of components of the memory system, where transmitting the lowest thermal margin is in accordance with determining the lowest thermal margin.

Aspect 9: The method, apparatus, or non-transitory computer-readable medium of any of aspects 1 through 8, further including operations, features, circuitry, logic, means, or instructions, or any combination thereof for determining an instantaneous temperature of each component of the plurality of components in accordance with monitoring the temperature of each component of the plurality of components and receiving the first command, where determining the respective thermal margin for each of the plurality of components of the memory system is in accordance with determining the instantaneous temperature of each component.

Aspect 10: The method, apparatus, or non-transitory computer-readable medium of aspect 9, where the instantaneous temperature of each component is in accordance with an ambient temperature associated with a respective component, a workload of a respective component, a proximity of a respective component to an external heat source, or any combination thereof.

Aspect 11: The method, apparatus, or non-transitory computer-readable medium of any of aspects 1 through 10, further including operations, features, circuitry, logic, means, or instructions, or any combination thereof for determining that an operating temperature of the memory system satisfies a first threshold temperature value that is associated with an upper bound of an operating temperature range of the memory system or a second threshold temperature value that is associated with a lower bound of the operating temperature range of the memory system and transmitting a fifth command indicating that the operating temperature of the memory system satisfies the first threshold temperature and the second threshold temperature in accordance with determining that the operating temperature of the memory system satisfies the first threshold temperature value and the second threshold temperature value.

Aspect 12: The method, apparatus, or non-transitory computer-readable medium of aspect 11, further including operations, features, circuitry, logic, means, or instructions, or any combination thereof for receiving a sixth command associated with adjusting the operating temperature of the memory system in accordance with transmitting the fifth command and performing one or more operations to adjust the operating temperature of the memory system in accordance with receiving the sixth command.

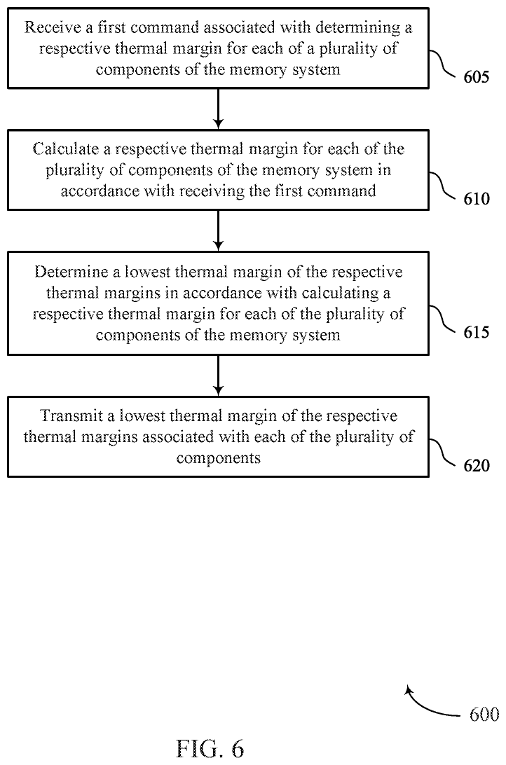

FIG. 6 shows a flowchart illustrating a method 600 that supports component based thermal margin reporting by a memory system in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving a first command associated with determining a respective thermal margin for each of a plurality of components of the memory system. In some examples, aspects of the operations of 605 may be performed by a reception component 430.

At 610, the method may include calculating a respective thermal margin for each of the plurality of components of the memory system in accordance with receiving the first command. In some examples, aspects of the operations of 610 may be performed by a calculation component 445.

At 615, the method may include determining a lowest thermal margin of the respective thermal margins in accordance with calculating a respective thermal margin for each of the plurality of components of the memory system. In some examples, aspects of the operations of 615 may be performed by a determination component 435.

At 620, the method may include transmitting a lowest thermal margin of the respective thermal margins associated with each of the plurality of components. In some examples, aspects of the operations of 620 may be performed by a transmission component 440.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 13: A method, apparatus, or non-transitory computer-readable medium including operations, features, circuitry, logic, means, or instructions, or any combination thereof for receiving a first command associated with determining a respective thermal margin for each of a plurality of components of the memory system; calculating a respective thermal margin for each of the plurality of components of the memory system in accordance with receiving the first command; determining a lowest thermal margin of the respective thermal margins in accordance with calculating a respective thermal margin for each of the plurality of components of the memory system; and transmitting a lowest thermal margin of the respective thermal margins associated with each of the plurality of components.

Aspect 14: The method, apparatus, or non-transitory computer-readable medium of aspect 13, further including operations, features, circuitry, logic, means, or instructions, or any combination thereof for determining a temperature of each component of a plurality of components in accordance with receiving the first command.

Aspect 15: The method, apparatus, or non-transitory computer-readable medium of aspect 14, where the temperature of each component is in accordance with an ambient temperature associated with a respective component, a workload of a respective component, a proximity of a respective component to an external heat source, or any combination thereof.

Aspect 16: The method, apparatus, or non-transitory computer-readable medium of any of aspects 13 through 15, further including operations, features, circuitry, logic, means, or instructions, or any combination thereof for receiving, in accordance with transmitting the lowest thermal margin, a second command associated with lowering a temperature of a component having the lowest thermal margin and performing one or more operations that result in cooling of the component having the lowest thermal margin in accordance with receiving the second command.

Aspect 17: The method, apparatus, or non-transitory computer-readable medium of any of aspects 13 through 16, further including operations, features, circuitry, logic, means, or instructions, or any combination thereof for receiving, by the memory system, a third command associated with determining a component of the plurality of components having the lowest thermal margin and transmitting an indication of the component having the lowest thermal margin in accordance with receiving the third command.

Aspect 18: The method, apparatus, or non-transitory computer-readable medium of aspect 17, further including operations, features, circuitry, logic, means, or instructions, or any combination thereof for determining, among a plurality of indicators associated with each of the plurality of components, an indicator associated with the component having the lowest thermal margin in accordance with receiving the third command and determining the respective thermal margin for each of the plurality of components of the memory system and generating a value in accordance with determining the indicator associated with the component having the lowest thermal margin, where the indication includes the value.

Aspect 19: The method, apparatus, or non-transitory computer-readable medium of any of aspects 13 through 18, further including operations, features, circuitry, logic, means, or instructions, or any combination thereof for receiving a fourth command associated with indicating a type of temperature monitoring performed by the memory system, where the type of temperature monitoring includes a first type associated with an enclosure temperature of the memory system or a second type associated with a temperature of one or more components of the memory system.

Aspect 20: The method, apparatus, or non-transitory computer-readable medium of aspect 19, further including operations, features, circuitry, logic, means, or instructions, or any combination thereof for transmitting an indication that the memory system performs the second type of temperature monitoring in accordance with receiving the fourth command and monitoring the temperature of each component of the plurality of components.

Aspect 21: The method, apparatus, or non-transitory computer-readable medium of any of aspects 13 through 20, where calculating the respective thermal margin for each of the plurality of components of the memory system includes operations, features, circuitry, logic, means, or instructions, or any combination thereof for calculating a difference between a maximum operating temperature of a respective component and a temperature of the respective component and an offset value.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
monitor a temperature of each component of a plurality of components;
receive a first command associated with determining a respective thermal margin for each of the plurality of components in accordance with monitoring the temperature of each component of the plurality of components;
determine the respective thermal margin for each of the plurality of components of the memory system in accordance with receiving the first command; and
transmit a lowest thermal margin of the respective thermal margins associated with each of the plurality of components.

2. The memory system of claim 1, wherein the processing circuitry is further configured to cause the memory system to:
receive, in accordance with transmitting the lowest thermal margin, a second command associated with lowering a temperature of a component having the lowest thermal margin; and
perform one or more operations that result in cooling of the component having the lowest thermal margin in accordance with receiving the second command.

3. The memory system of claim 1, wherein the processing circuitry is further configured to cause the memory system to:
receive, by the memory system, a third command associated with determining a component of the plurality of components having the lowest thermal margin; and
transmit an indication of the component having the lowest thermal margin in accordance with receiving the third command.

4. The memory system of claim 3, wherein the processing circuitry is further configured to cause the memory system to:
determine, among a plurality of indicators associated with each of the plurality of components, an indicator associated with the component having the lowest thermal margin in accordance with receiving the third command and determining the respective thermal margin for each of the plurality of components of the memory system; and
generate a value in accordance with determining the indicator associated with the component having the lowest thermal margin, wherein the indication comprises the value.

5. The memory system of claim 1, wherein the processing circuitry is further configured to cause the memory system to:
receive a fourth command associated with indicating a type of temperature monitoring performed by the memory system, wherein the type of temperature monitoring comprises a first type associated with an enclosure temperature of the memory system or a second type associated with a temperature of one or more components of the memory system.

6. The memory system of claim 5, wherein the processing circuitry is further configured to cause the memory system to:
transmit an indication that the memory system performs the second type of temperature monitoring in accordance with receiving the fourth command and monitoring the temperature of each component of the plurality of components.

7. The memory system of claim 1, wherein to determine the respective thermal margin for each of the plurality of components of the memory system, the processing circuitry is configured to cause the memory system to:
determine a difference between a maximum operating temperature of a respective component and a summation of the temperature of the respective component and an offset value.

8. The memory system of claim 1, wherein the processing circuitry is further configured to cause the memory system to:
determine, among the respective thermal margins for each of the plurality of components, the lowest thermal margin in accordance with determining the respective thermal margin for each of the plurality of components of the memory system, wherein transmitting the lowest thermal margin is in accordance with determining the lowest thermal margin.

9. The memory system of claim 1, wherein the processing circuitry is further configured to cause the memory system to:
determine an instantaneous temperature of each component of the plurality of components in accordance with monitoring the temperature of each component of the plurality of components and receiving the first command, wherein determining the respective thermal margin for each of the plurality of components of the memory system is in accordance with determining the instantaneous temperature of each component.

10. The memory system of claim 9, wherein the instantaneous temperature of each component is in accordance with an ambient temperature associated with a respective component, a workload of a respective component, a proximity of a respective component to an external heat source, or any combination thereof.

11. The memory system of claim 1, wherein the processing circuitry is further configured to cause the memory system to:
determine that an operating temperature of the memory system satisfies a first threshold temperature value that is associated with an upper bound of an operating temperature range of the memory system or a second threshold temperature value that is associated with a lower bound of the operating temperature range of the memory system; and
transmit a fifth command indicating that the operating temperature of the memory system satisfies the first threshold temperature value and the second threshold temperature value in accordance with determining that the operating temperature of the memory system satisfies the first threshold temperature value and the second threshold temperature value.

12. The memory system of claim 11, wherein the processing circuitry is further configured to cause the memory system to:
receive a sixth command associated with adjusting the operating temperature of the memory system in accordance with transmitting the fifth command; and
perform one or more operations to adjust the operating temperature of the memory system in accordance with receiving the sixth command.

13. A memory system, comprising:
one or more memory devices; and
processing circuitry coupled with the one or more memory devices and configured to cause the memory system to:
receive a first command associated with determining a respective thermal margin for each of a plurality of components of the memory system;
calculate a respective thermal margin for each of the plurality of components of the memory system in accordance with receiving the first command;
determine a lowest thermal margin of the respective thermal margins in accordance with calculating a respective thermal margin for each of the plurality of components of the memory system; and
transmit a lowest thermal margin of the respective thermal margins associated with each of the plurality of components.

14. The memory system of claim 13, wherein the processing circuitry is further configured to cause the memory system to:
determine a temperature of each component of a plurality of components in accordance with receiving the first command.

15. The memory system of claim 14, wherein the temperature of each component is in accordance with an ambient temperature associated with a respective component, a workload of a respective component, a proximity of a respective component to an external heat source, or any combination thereof.

16. The memory system of claim 13, wherein the processing circuitry is further configured to cause the memory system to:
receive, in accordance with transmitting the lowest thermal margin, a second command associated with lowering a temperature of a component having the lowest thermal margin; and
perform one or more operations that result in cooling of the component having the lowest thermal margin in accordance with receiving the second command.

17. The memory system of claim 13, wherein the processing circuitry is further configured to cause the memory system to:
receive, by the memory system, a third command associated with determining a component of the plurality of components having the lowest thermal margin; and
transmit an indication of the component having the lowest thermal margin in accordance with receiving the third command.

18. The memory system of claim 17, wherein the processing circuitry is further configured to cause the memory system to:
determine, among a plurality of indicators associated with each of the plurality of components, an indicator associated with the component having the lowest thermal margin in accordance with receiving the third command and determining the respective thermal margin for each of the plurality of components of the memory system; and
generate a value in accordance with determining the indicator associated with the component having the lowest thermal margin, wherein the indication comprises the value.

19. The memory system of claim 13, wherein the processing circuitry is further configured to cause the memory system to:
receive a fourth command associated with indicating a type of temperature monitoring performed by the memory system, wherein the type of temperature monitoring comprises a first type associated with an enclosure temperature of the memory system or a second type associated with a temperature of one or more components of the memory system.

20. The memory system of claim 19, wherein the processing circuitry is further configured to cause the memory system to:
transmit an indication that the memory system performs the second type of temperature monitoring in accordance with receiving the fourth command and monitoring the temperature of each component of the plurality of components.

21. The memory system of claim 13, wherein to calculate the respective thermal margin for each of the plurality of components of the memory system, the processing circuitry is configured to cause the memory system to:
calculate a difference between a maximum operating temperature of a respective component and a temperature of the respective component and an offset value.

22. A non-transitory computer-readable medium storing code comprising instructions which, when executed by processing circuitry of a memory system, cause the memory system to:
monitor a temperature of each component of a plurality of components;
receive a first command associated with determining a respective thermal margin for each of the plurality of components in accordance with monitoring the temperature of each component of the plurality of components;
determine the respective thermal margin for each of the plurality of components of the memory system in accordance with receiving the first command; and
transmit a lowest thermal margin of the respective thermal margins associated with each of the plurality of components.

23. The non-transitory computer-readable medium of claim 22, wherein the instructions, when executed by the processing circuitry of the memory system, further cause the memory system to:
receive, in accordance with transmitting the lowest thermal margin, a second command associated with lowering a temperature of a component having the lowest thermal margin; and
perform one or more operations that result in cooling of the component having the lowest thermal margin in accordance with receiving the second command.

24. The non-transitory computer-readable medium of claim 22, wherein the instructions, when executed by the processing circuitry of the memory system, further cause the memory system to:
receive, by the memory system, a third command associated with determining a component of the plurality of components having the lowest thermal margin; and
transmit an indication of the component having the lowest thermal margin in accordance with receiving the third command.

25. The non-transitory computer-readable medium of claim 24, wherein the instructions, when executed by the processing circuitry of the memory system, further cause the memory system to:
determine, among a plurality of indicators associated with each of the plurality of components, an indicator associated with the component having the lowest thermal margin in accordance with receiving the third command and determining the respective thermal margin for each of the plurality of components of the memory system; and
generate a value in accordance with determining the indicator associated with the component having the lowest thermal margin, wherein the indication comprises the value.
